(19) United States
(12) Patent Application Publication
(10) Pub. No.: US 2020/0112475 A1
(43) Pub. Date: Apr. 9, 2020

(54) REAL-TIME ADAPTIVE INFRASTRUCTURE SCENARIO IDENTIFICATION USING SYNTACTIC GROUPING AT VARIED SIMILARITY

(71) Applicant: CA, Inc., New York, NY (US)

(72) Inventors: Sai Eswar GARAPATI, Andra Pradesh (IN); Deepak KARUNANIDHI, Hyderabad (IN); Rajat Kumar MISHRA, Hyderabad (IN)

(73) Assignee: CA, Inc., New York, NY (US)

(21) Appl. No.: 16/154,393

(22) Filed: Oct. 8, 2018

(51) Int. Cl. H04L 12/24; G06F 17/30; G06F 17/27

(52) U.S. Cl. CPC H04L 41/0609; G06F 17/30616; H04L 41/0631; G06F 17/277; G06F 17/30705

(57) ABSTRACT

Methods of processing alarm messages in a computer network administration system are provided. Methods include receiving a substantially real time alarm message stream that includes alarm messages. For each alarm message, operations include performing a message preprocessing operation to remove low message content portions, determining message term relevance corresponding to message terms in the alarm message, and converting the message terms into a message vector. Operations further include generating scenarios that represent respective message clusters based on varied similarity distance between given ones of the message vectors.

### BACKGROUND

The present disclosure relates to processing of alarm messages in computing systems, and in particular to the clustering of alarm messages.

Computer networks, particularly large, distributed computer networks, are managed by computer network management systems that receive and process alarm messages from various network elements. Alarm messages may be presented to computer administrators, who may determine what caused the alarm message and how to address it. In a large computer network, the volume of messages can become large to the point of being intractable, particularly if multiple issues arise in the computer network in a short period of time.

In such instances, it is helpful for the computer administrators to have the alarm messages organized in a manner such that related messages are grouped together so that they can be processed and addressed together, rather than as unrelated incidents. The process of grouping related alarm messages is referred to as “clustering.” Unfortunately, however, it may be difficult to determine which alarm messages are related, as many alarm messages have similar structure and content.

Some efforts have been undertaken to computationally cluster documents for various purposes, such as searching for related documents. Historically, grouping of documents has been performed by measuring relationships between the documents using schemes such as a term frequency-inverse document frequency (TF-IDF) weighting scheme. In a TF-IDF approach, both the frequency of appearance of individual words in a document and the frequency of appearance of the word in the overall corpus of documents is measured. The relative importance of a particular word in a document is determined based on its frequency of appearance in the document and its inverse frequency in the overall corpus. Thus, if a term appears frequently in a given document but infrequently overall, then the document in question is deemed to be more relevant to that term.

Using a TF-IDF approach, each document is represented as a vector of terms, and a similarity function that compares similarity of the document vectors is used to group documents into related clusters. Latent Semantic Analysis (LSA) is a technique that employs TF-IDF to analyze relationships between documents. Latent Semantic Analysis assumes that the cognitive similarity between any two words is reflected in the way they co-occur in small subsamples of the language. LSA is implemented by constructing a matrix with rows corresponding to the documents in the corpus, and the columns labeled by the attributes (words, phrases). The entries are the number of times the column attribute occurs in the row document. The entries are then processed by taking the logarithm of the entry and dividing it by the number of documents the attribute occurred in, or some other normalizing function. This results in a sparse but high-dimensional matrix A. Typical approaches to LSA then attempt to reduce the dimensionality of the matrix by projecting it into a subspace of lower dimension using singular value decomposition. Subsequently, the cosine between vectors is evaluated as an estimate of similarity between the terms. However, application of LSA on large datasets may be computationally challenging, and may not adequately capture semantic relationships between documents.

### SUMMARY

Some embodiments are directed to methods of processing alarm messages in a computer network administration system. Such methods may include receiving a substantially real time alarm message stream that includes multiple alarm messages. For each alarm message, operations may include performing a message preprocessing operation to remove low message content portions of the alarm message, determining message term relevance corresponding to message terms in the alarm message, converting the plurality message terms into a message vector. Operations may include generating multiple scenarios that represent respective message clusters based on varied similarity between given ones of message vectors.

Some embodiments include transmitting the scenarios that are based on the message clusters to a system operator via an external interface.

In some embodiments, performing the message preprocessing operation includes removing ascii characters from the alarm messages, removing special characters from the alarm messages, excluding stop words from the alarm messages by excluding words other than nouns and verbs from the terms in the alarm messages, and performing a natural language based tokenization on the alarm messages. The preprocessing operation may further include performing a stemming operation on the alarm messages to convert message terms that include variations of the same root term into a single stem term, and performing a lemmatization operation on the alarm messages to convert message terms that are synonyms with one another to a single term.

In some embodiments, determining message term relevance includes determining a frequency of use of ones of the message terms within each of the of alarm messages and determining a frequency of use of the message terms in all of the alarm messages. In some embodiments, the frequency of use is negatively correlated with the message term relevance.

In some embodiments, generating the scenarios includes generating the scenarios without receiving a similarity threshold.

Some embodiments provide that generating the scenarios include determining a similarity matrix using a distance function, wherein the similarity matrix corresponding to N messages comprises N rows and N columns. Some embodiments provide that each element in the similarity matrix is a similarity value corresponding to the message row and the message column of that element.

In some embodiments, generating the scenarios includes generating a connected graph as an adjacency matrix representation of data in the similarity matrix. Some embodiments provide generating a minimum spanning tree based on the connected graph. In some embodiments, the minimum spanning tree includes an arrangement of the messages and the distances therebetween that includes a minimum total distance of the messages. Some embodiments provide generating a broken cluster tree having the minimum spanning tree arranged in an order from a first distance to a second distance that is greater than the first distance. In some embodiments, generating the scenarios includes removing clusters that do not include at least two nodes in the broken cluster tree. Some embodiments include determining similarity distances between starting and ending nodes of ones of the message clusters. Some embodiments include determining a rate of change of similarity at each of multiple similarity distance levels.

Some embodiments include receiving a new alarm message, determining a varied similarity between the new alarm message and given ones of the message vectors, grouping the new alarm message into an existing scenario, and displaying the new alarm message in association with the existing cluster of alarm messages.

Some embodiments herein are directed to a network management server that includes a processing circuit and a memory coupled to the processing circuit, the memory including machine-readable instructions that, when executed by the processing circuit cause the processing circuit to receive a substantially real time alarm message stream that includes multiple alarm messages. The processor further performs a message preprocessing operation to remove low message content portions of the alarm message, determines message term relevance corresponding to multiple message terms in the alarm message and converts the message terms into a message vector. Scenarios that represent respective ones of multiple message clusters are generated based on varied similarity between given ones of multiple message vectors. The scenarios that are based on the message clusters are transmitted to a system operator via an external interface.

In some embodiments, the preprocessing operation includes removing ascii characters from the alarm messages, removing special characters from the alarm messages, excluding stop words from the alarm messages by excluding words other than nouns and verbs from the terms in the alarm messages, performing a natural language based tokenization on the alarm messages, performing a stemming operation on the alarm messages to convert message terms that include variations of the same root term into a single stem term, and performing a lemmatization operation on the alarm messages to convert message terms that are synonyms with one another to a single term.

Some embodiments provide that determining message term relevance includes determining a frequency of use of ones of the message terms within each of the alarm messages and determining a frequency of use of ones of the message terms in all of the alarm messages. Some embodiments provide that frequency of use is negatively correlated with the message term relevance.

In some embodiments, generating the scenarios includes generating the scenarios without receiving a similarity threshold.

Some embodiments provide determining a similarity matrix using a distance function, wherein the similarity matrix corresponding to N messages comprises N rows and N columns, wherein each element in the similarity matrix comprises a similarity value corresponding to the message row and the message column of that element. In some embodiments, a connected graph may be generated as an adjacency matrix representation of data in the similarity matrix and a minimum spanning tree based on the connected graph is generated. In some embodiments, the minimum spanning tree includes an arrangement of the messages and the distances therebetween that include a minimum total distance of the plurality of messages. A broken cluster tree having the minimum spanning tree arranged in an order from a first distance to a second distance that is greater than the first distance may be generated. Clusters that do not include at least two nodes in the broken cluster tree may be removed. Similarity distances between starting and ending nodes of ones of the message clusters may be determined, and a rate of change of similarity at each of similarity distance levels is determined.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of a network management server according to some embodiments of the inventive concepts.

FIG. 3 is a block diagram of a network system according to embodiments of the inventive concepts.

FIG. 4 is a flowchart illustrating operations of systems/methods in accordance with some embodiments of the inventive concepts.

FIG. 5 is a flowchart illustrating operations for preprocessing alarm messages in accordance with some embodiments of the inventive concepts.

FIG. 6 is a flowchart illustrating operations for determining message term relevance in accordance with some embodiments of the inventive concepts.

FIG. 7 is a flowchart illustrating operations for generating scenarios representing clusters of messages in accordance with some embodiments of the inventive concepts.

FIG. 8 is a schematic diagram illustrating a minimum spanning tree according to some embodiments of the inventive concepts.

FIG. 9 is a schematic diagram illustrating a broken cluster tree according to some embodiments of the inventive concepts.

FIG. 10 is a schematic diagram illustrating a broken cluster tree with cluster labels according to some embodiments of the inventive concepts.

FIG. 11 is a schematic diagram illustrating a broken cluster tree with updated cluster labels according to some embodiments of the inventive concepts.

FIG. 12 is a table including comparative results using fixed value similarity thresholds and a variable similarity threshold according to some embodiments of the inventive concepts.

FIG. 13 is a screen shot of an example external interface for presenting alarm message scenarios according to some embodiments of the inventive concepts.

FIG. 14 is a block diagram of a computing system which can be configured as a network management server according to some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Some embodiments provide systems and/or methods include a streaming/on-line platform that will create scenarios from real-time messages. Such methods may reduce initial noise by deduplicating the messages. Custom natural language methods may be used to tokenize and reduce data noise corresponding to the messages. Significant data may be identified using text mining techniques. Different messages may be correlated and/or connected using grouping techniques that may address noise at varied similarity to identify scenarios.

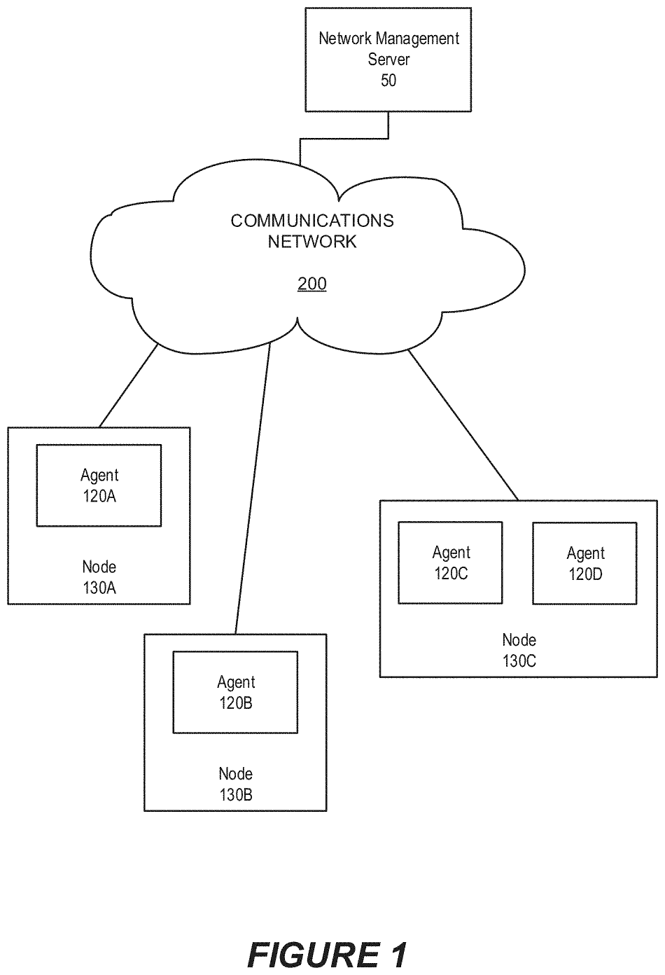

FIG. 1 is a block diagram of a distributed computing network in which systems/methods according to embodiments of the inventive concepts may be employed. Referring to FIG. 1, a plurality of nodes 130A-130D are provided. The nodes 130A-130D may be generally referred to as nodes 130. The nodes 130 may be physical devices, such as servers that have processors and associated resources, such as memory, storage, communication interfaces, etc., or virtual machines that have virtual resources assigned by a virtual hypervisor. The nodes communicate over a communications network 200, which may be a private network, such as a local area network (LAN) or wide area network (WAN), or a public network, such as the Internet. The communications network 200 may use a communications protocol, such as TCP/IP, in which each network node is assigned a unique network address, or IP address.

One or more of the nodes 130 may host one or more agents 120, which are software applications configured to perform functions in the nodes. In the distributed computing environment illustrated in FIG. 1, messages may be sent to the agents 120, which may process the messages and transmit responses to the messages.

In the distributed computing network illustrated in FIG. 1, each of the nodes 130 in the network may generate and transmit alarm messages to a network management server 50 in response to events occurring at the network elements. Alarm messages may be generated based on many different types of events, such as data transmission failures or delays, timeouts, and/or capacity, throughput, utilization or other metrics exceeding defined thresholds. When the network management server 50 receives the alarm messages, it may be helpful to group the messages syntactically so that related alarm messages can be dealt with in a coordinated manner.

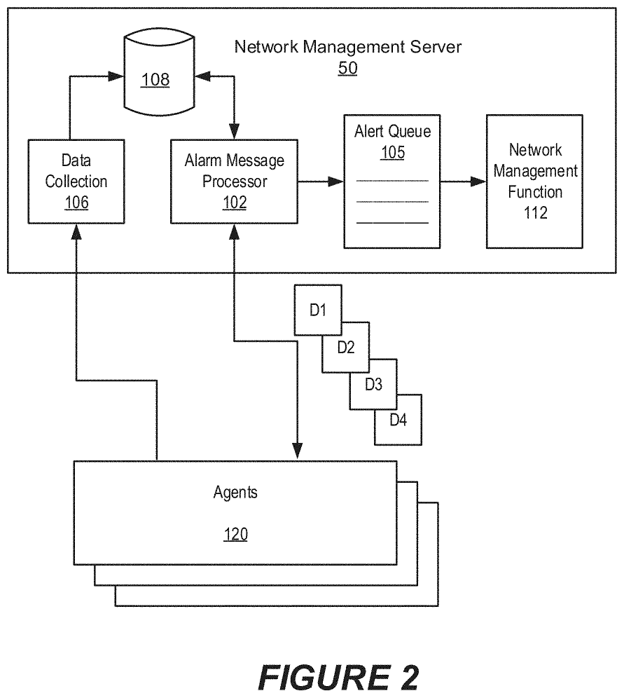

FIG. 2 is a block diagram of a network management server 50 according to some embodiments showing components of the network management server 50 in more detail. The network management server 50 includes various modules that communicate with one another to perform the workload scheduling function. For example, the network management server 50 includes a data collection module 106, an alarm message processor 102, a database 108, a network management function 112 and an alert queue 105. It will be appreciated that the network management server 50 may be implemented on a single physical or virtual machine, or its functionality may be distributed over multiple physical or virtual machines. Moreover, the database 108 may be located in the network management server 50 or may be accessible to the scheduler 100 over a communication interface. The data collection module 106 may collect data from agents 120 in the distributed computing network, and may store collected data in the database 108. From time to time, the agents 120 may generate alarm messages D1, D2, etc., and transmit the alarm messages to the network management server 50. Alarm messages typically report error conditions or other conditions that may require intervention by the network management function 112. Accordingly, alarm messages may be reported to an alarm message processor 102 which receives the alarm messages and places the alarm messages in an alert queue 105 for handling by a network management system. The alarm message processor 102 may also store the alarm messages in the database 108 for later use and/or analysis.

As noted above, one problem faced by a network management function 112 is that a very large number of alarm messages can be generated in a distributed communication network, and it can be very difficult for a network operator to process all of the alarm messages. Accordingly, in such instances, it is helpful for the computer administrators to have the alarm messages organized in a manner that related messages are grouped together so that they can be processed and addressed together, rather than as unrelated incidents, in a process known as clustering. Some embodiments described herein process alarm messages using a real time adaptive scenario identification using grouping at varied similarity thresholds to extract syntactic relationships between alarm messages that can be used to cluster the alarm messages in a meaningful way. Such clustered alarm messages may then be processed by a network management function in a more efficient manner.

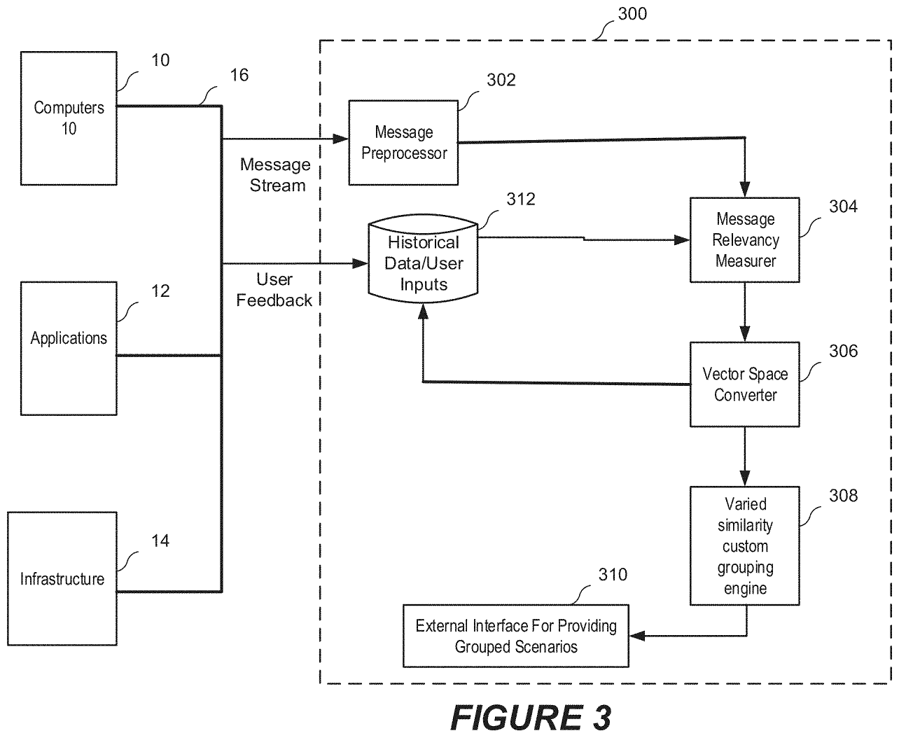

Reference is now made to FIG. 3, which is a block diagram of a network system according to embodiments of the inventive concepts. A system 300 may provide real time adaptive infrastructure scenario identification using syntactic grouping at varied similarity. The system 300 may receive a message stream of real time alarm messages into a message preprocessor 302. The message preprocessor 302 may perform a message preprocessing operation to remove low message content portions of the alarm message.

In some embodiments, the preprocessing operation includes removing ascii and special characters from the alarm messages, excluding stop words from the alarm messages by excluding words other than nouns and verbs from the terms in the alarm messages, performing a natural language based tokenization on the alarm messages, performing a stemming operation on the alarm messages to convert message terms that include variations of the same root term into a single stem term, and performing a lemmatization operation on the alarm messages to convert message terms that are synonyms with one another to a single term.

The system 300 may include a message relevance measurer 304 that is configured to determine message term relevance corresponding to multiple message terms in the alarm message. Determining message term relevance may include determining a frequency of use of ones of the message terms within each of the alarm messages and determining a frequency of use of the message terms in all of the alarm messages. Some embodiments provide that the frequency of use is negatively correlated with the message term relevance.

The system 300 may include a vector space converter 306 that is configured to convert the message terms into a message vector and a varied similarity custom grouping engine 308 that is configured to generate multiple scenarios that represent respective message clusters based on varied similarity between ones of the message vectors, and transmit the scenarios that are based on the message clusters to a system operator via an external interface 310. The scenarios may be generated without receiving a similarity threshold value or input.

The varied similarity custom grouping engine 308 generates the multiple scenarios by determining a similarity matrix using a distance function. The similarity matrix corresponding to N messages includes N rows and N columns. Each element in the similarity matrix includes a similarity value corresponding to the message row and the message column of that element. A connected graph is generated as an adjacency matrix representation of data in the similarity matrix and a minimum spanning tree is generated based on the connected graph. The minimum spanning tree includes an arrangement of the messages and the distances therebetween that include a minimum total distance of the plurality of messages. A broken cluster tree having the minimum spanning tree arranged in an order from a first distance to a second distance that is greater than the first distance is generated and clusters that do not include at least two nodes in the broken cluster tree are removed. Similarity distances between starting and ending nodes of ones of the message clusters are determined, and a rate of change of similarity at each similarity distance level is determined.

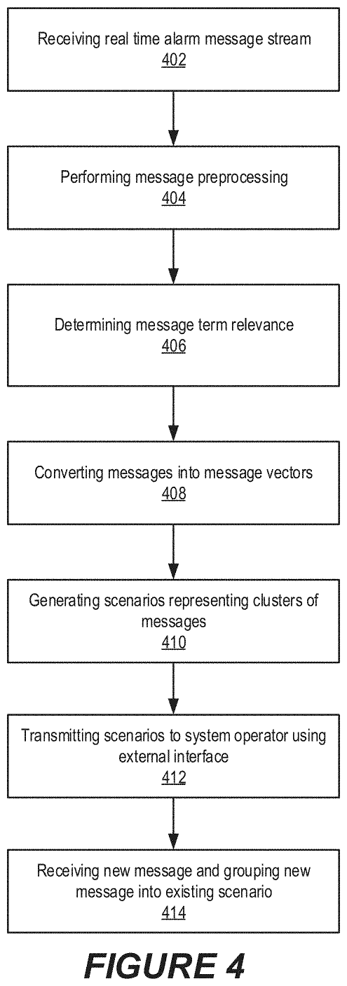

Reference is now made to FIG. 4, which is a flowchart illustrating operations of systems/methods in accordance with some embodiments of the inventive concepts. The block diagram may include operations corresponding to methods of processing alarm messages in a computer network administration system. For example, operations may include receiving a real time alarm message stream that includes multiple alarm messages (block 402). Some embodiments provide that alarm messages may be generated and sent by computers connected to the network, applications that are operating in the network and/or from network infrastructure devices, among others. For each of the received alarm messages, a preprocessing operation may be performed (block 404). The message preprocessing operation may remove low message content portions of the alarm message.

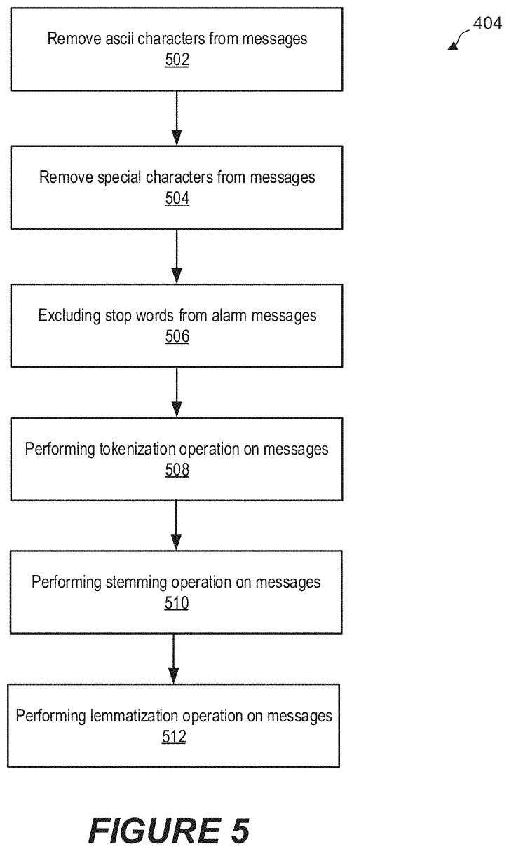

Reference is made to FIG. 5, which is a flowchart illustrating operations for preprocessing alarm messages in accordance with some embodiments of the inventive concepts. Preprocessing operations may include removing ascii characters from the alarm message (block 502). In some embodiments, the ascii characters may be removed from the message as they may have limited informational value that corresponds to the specific alarm message. Similarly, special characters may be removed from the alarm messages for similar reasons as the ascii characters (block 504). Operations include removing stop words from the alarm messages (block 506). Some embodiments provide that stop words may include verbs, articles, prepositions and/or terms that have been previously identified as having limited informational content regarding the alarm message and/or regarding clustering ones of the alarm messages.

In some embodiments, a natural language based tokenization on the alarm message may be performed (block 508). Tokenization may include a process of demarcating and possibly classifying sections of a string of input characters. The process may be a sub-task of parsing the alarm messages. Operations may include performing a performing a stemming operation on the alarm messages (block 510). The tokenization may operate to convert message terms that include variations of the same root term into a single stem term. A lemmatization operation may be performed on the alarm messages (block 512). In some embodiments, the lemmatization may convert message terms that are synonyms with one another to a single term.

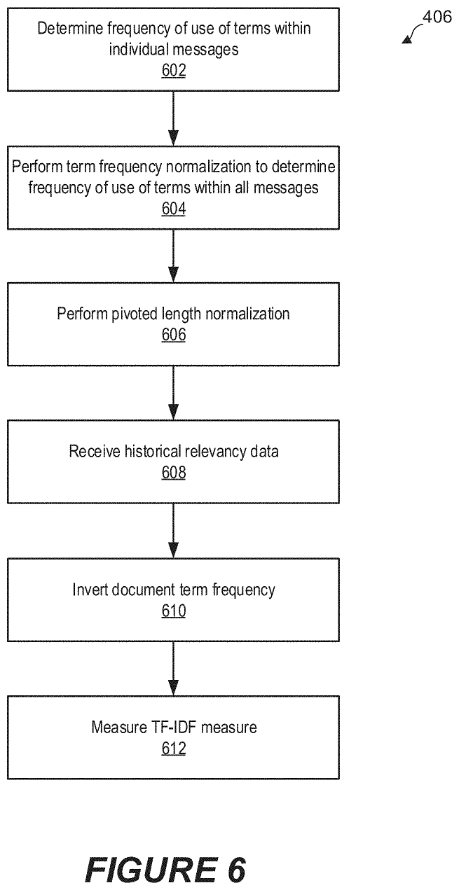

Briefly referring back to FIG. 4, operations may include determining message term relevance corresponding to terms that are in the alarm messages (block 406). Reference is now made to FIG. 6, which is a flowchart illustrating operations for determining message term relevance in accordance with some embodiments of the inventive concepts. As such, operations may include determining a frequency of use of a term within each of the alarm messages (block 602). Additionally, operations may include performing a term frequency normalization to determine frequency of use of terms within multiple alarm messages (block 604). In some embodiments, the number of occurrences of a given term in a message may indicate that the term has a low relevance to the information content of the alarm message. As such, the frequency of use of a term may be negatively correlated with the relevance of the term. Operations may include performing a pivotal length normalization on the alarm messages (block 608). Pivotal length normalization may be used to modify a normalization function to reduce a gap between the relevance and the retrieval probabilities. The pivotal length normalization may include use with a cosine normalization function.

In some embodiments, historical relevancy data may be received and/or retrieved, for example, from a data repository (block 608). The historical relevancy data may boost or suppress the relevancy of different terms. An inverse document frequency corresponding to the terms is performed (block 610) and a custom term frequency-inverse document frequency (TF-IDF) may be measured (block 612). The TF-IDF may be used as a numerical statistic that indicates how important a term is to the alarm messages.

Referring back to FIG. 4, the messages are converted from text space to vector space to generate a message vector model (block 408). Messages in the vector model may include elements with real-valued TF-IDF weights as elements therein.

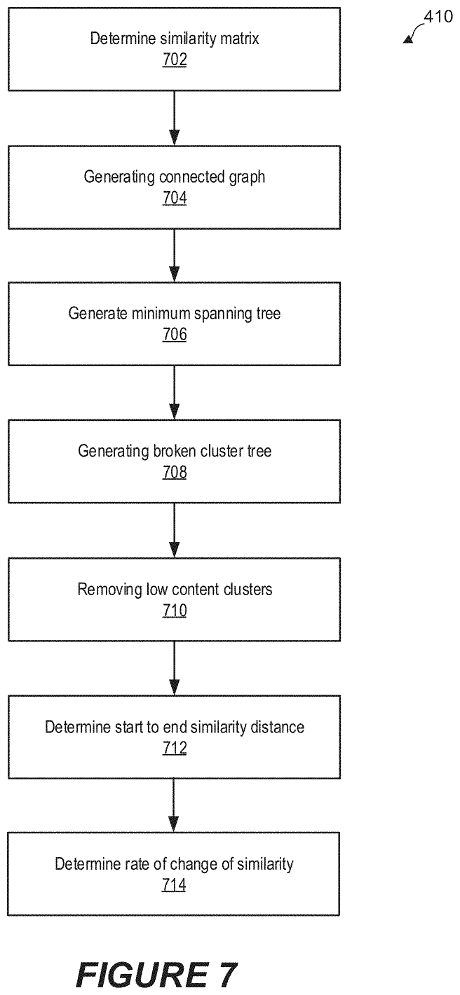

Operations may further include generating multiple scenarios that represent different message clusters based on varied similarity between ones of the message vectors (block 410). In contrast with conventional similarity based techniques, embodiments herein may generate the scenarios that represent message clusters based on varied similarity between message vectors without receiving or predetermining a similarity threshold. Reference is now made to FIG. 7, which is a flowchart illustrating operations for generating scenarios representing clusters of messages in accordance with some embodiments of the inventive concepts. Operations include determining a similarity matrix using a distance function (block 702). Some embodiments provide that the similarity matrix corresponding to N messages will be dimensioned to include N rows and N columns. In some embodiments, each element in the similarity matrix includes a similarity value that corresponds to the similarity between the message of the corresponding row and the message of the corresponding column. For example, a matrix element in row 3 and column 4 has a value that represents the similarity distance between alarm message 3 and alarm message 4. The similarity matrix may be generated by applying the cosine distance function to the message vectors.

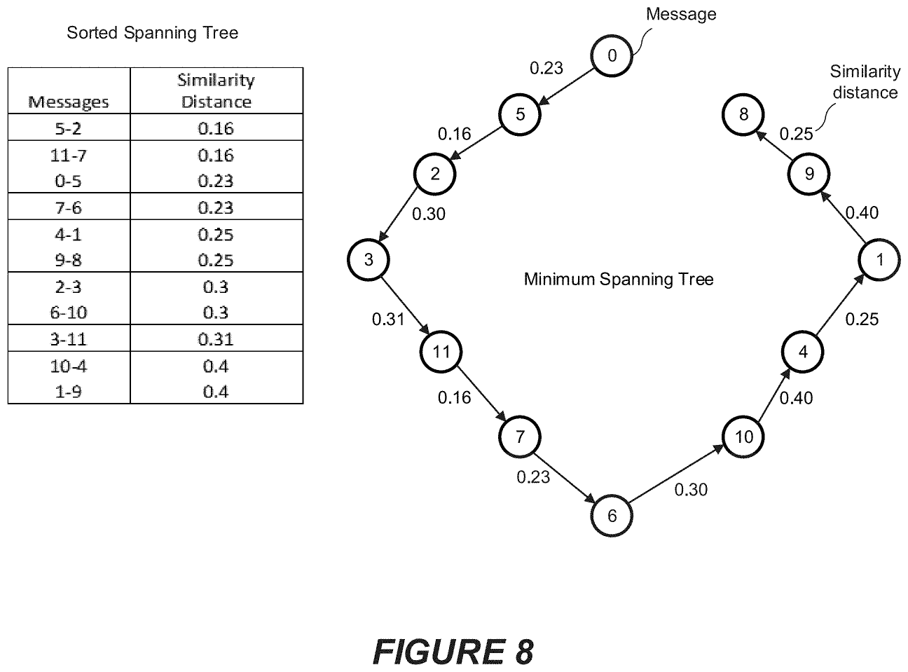

Referring to block 704, a connected graph may be generated as an adjacency matrix representation of the data in the similarity matrix. Using the connected graph, a minimum spanning tree may be generated (block 706). For example, brief reference is now made to FIG. 8, which is a schematic diagram illustrating a minimum spanning tree according to some embodiments of the inventive concepts. The minimum spanning tree comprises a node corresponding to each message and a similarity distance between adjacent nodes. The minimum spanning tree is the route and order of all of the nodes that has the minimum total distance. For example, the similarity distance between nodes corresponding to message 0 and message 5 is 0.23. The sorted spanning tree includes the message pairs sorted by their respective similarity distances.

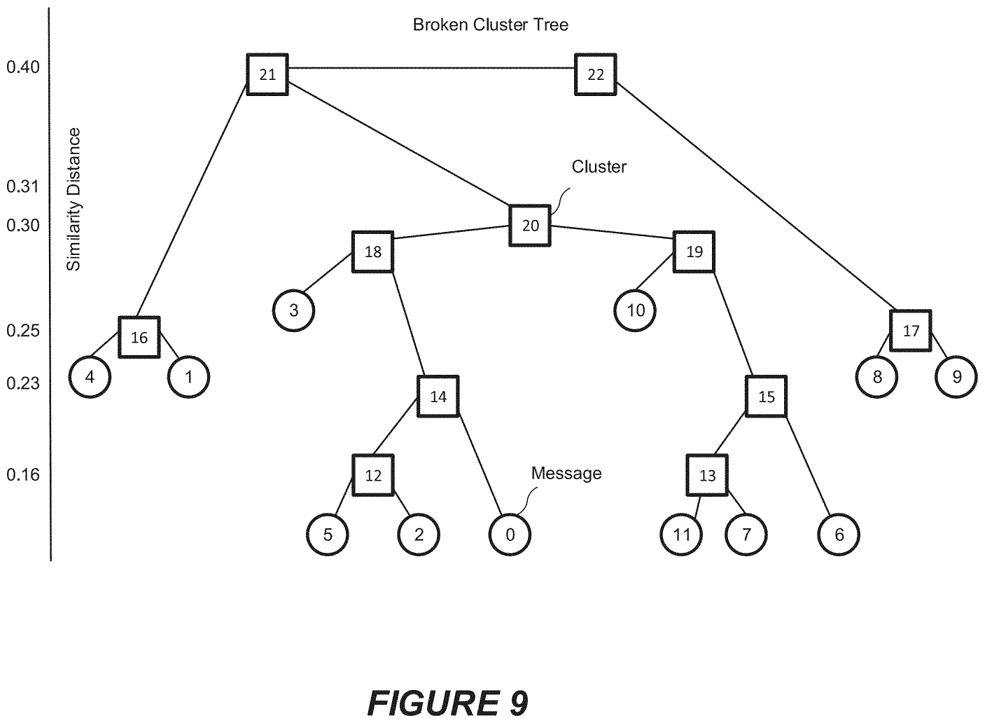

Referring back to FIG. 7, a broken cluster tree may be generated from the minimum spanning tree (block 708). Reference is made to FIG. 9, which is a schematic diagram illustrating a broken cluster tree according to some embodiments of the inventive concepts. The broken cluster tree may be generated by arranging the minimum spanning tree in an order from a first distance to a second distance that is greater than the first distance. As illustrated, the each of the numbered circles in the figure represents a node corresponding to one of the multiple alarm messages and each of the numbered rectangular elements represents a cluster of more than one alarm message. Each of the nodes corresponding to the alarm messages is located as a vertical position that corresponds to the similarity distance as illustrated on the vertical axis.

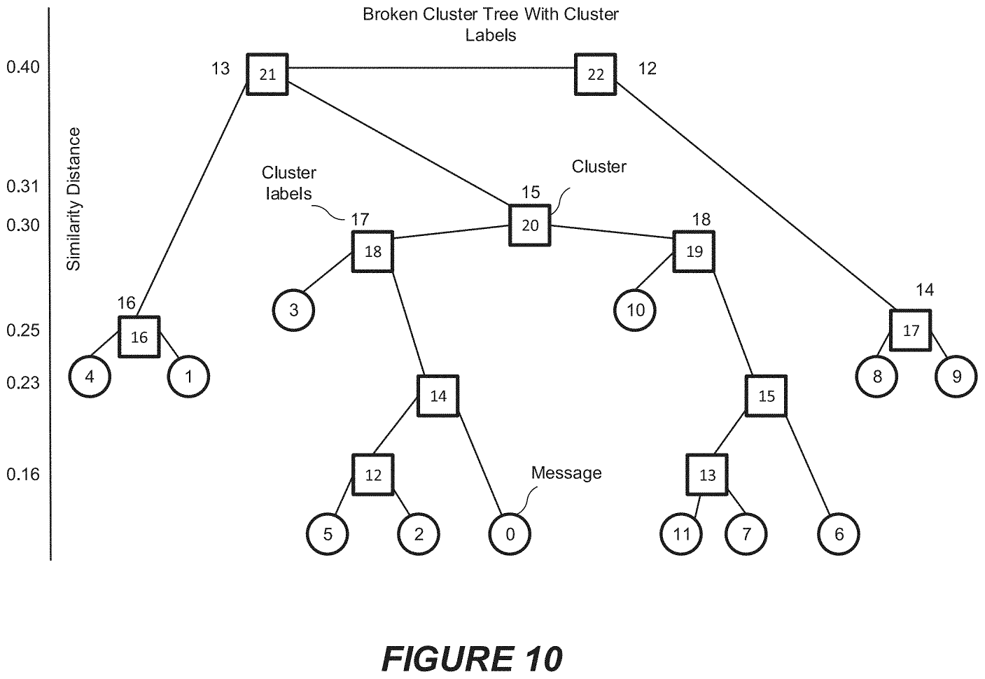

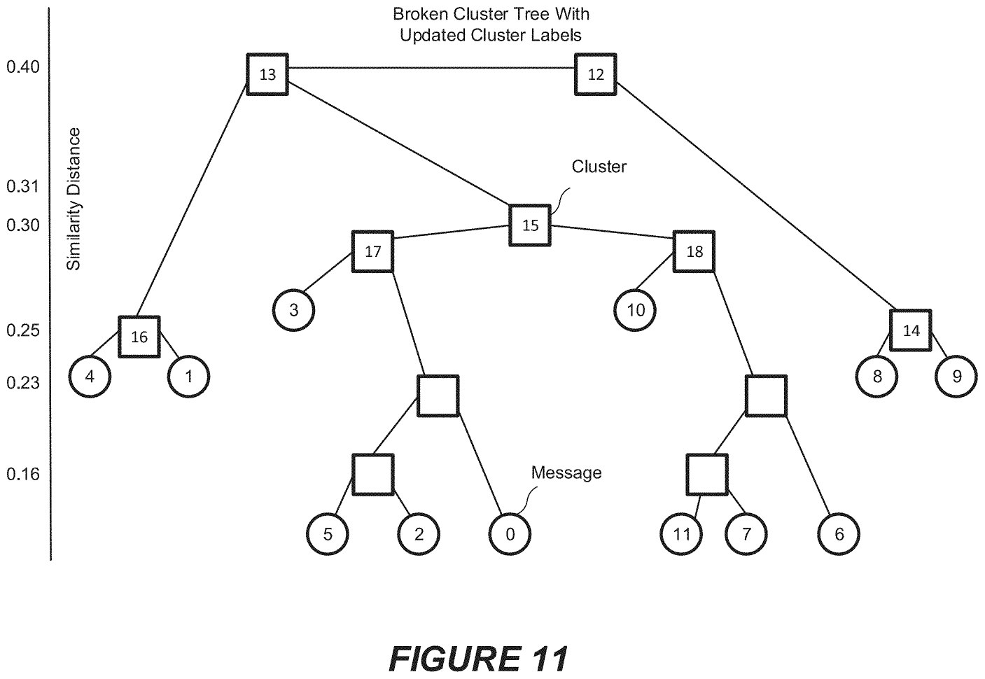

Referring back to FIG. 7, clusters that do not include at least two alarm message nodes in the broken cluster tree may be removed from consideration (block 710). For example, brief reference is now made to FIG. 10, which is a schematic diagram illustrating a broken cluster tree with cluster labels according to some embodiments of the inventive concepts. As illustrated, the cluster labels are indexed to only consider clusters have a given number of alarm message nodes. Brief reference is made to FIG. 11, which is a schematic diagram illustrating a broken cluster tree with updated cluster labels according to some embodiments of the inventive concepts. As illustrated, the clusters have been re-indexed to only include those clusters having non-trivial membership. For example, a cluster of 2 alarm messages may not provide a significant advantage in providing such a narrow scenario.

Referring back to FIG. 7, similarity distances between starting and ending nodes of ones of the message clusters may be determined (block 712). A rate of change of similarity at each of the similarity distance levels may be determined (block 714). In some embodiments, the rate of change at each similarity distance level may be determined by:

R_{ci}=log(Dₛₜ/Dₑ)/log(Cₛₜ/Cₑ) [1]

where Dₛₜ is the similarity distance of the starting node, Dₑ is the similarity distance of the ending node, Cₛₜ is the similarity distance of a child starting node and Cₑ is the similarity distance of a child ending node. In circumstances in which the parent's rate of change is less than the rate of change of the sum of the children, the child clusters may be discarded and the parent's rate of change will be used. Otherwise, the childrens' rate of change may be adopted and the analysis may propagate upward until the root of the broken cluster tree is reached. The cluster labels corresponding to the resulting clusters may be returned as scenarios that include multiple alarm messages.

Referring back to FIG. 4, scenarios that are based on the message clusters may be transmitted to a system operator via an external interface (block 412). According to some embodiments, operators may not have to wait for a process to complete to receive results because the operations herein are operative to provide real-time results on a streaming basis. Further, although real-time results are provided, operations herein are adaptive as they leverage propagated historical data. For example, operations may include receiving a new alarm message, determining a varied similarity between the new alarm message and given ones of the message vectors, and grouping the new alarm message into an existing scenario (block 414). Operations may further include displaying the new alarm message in association with the existing cluster of alarm messages.

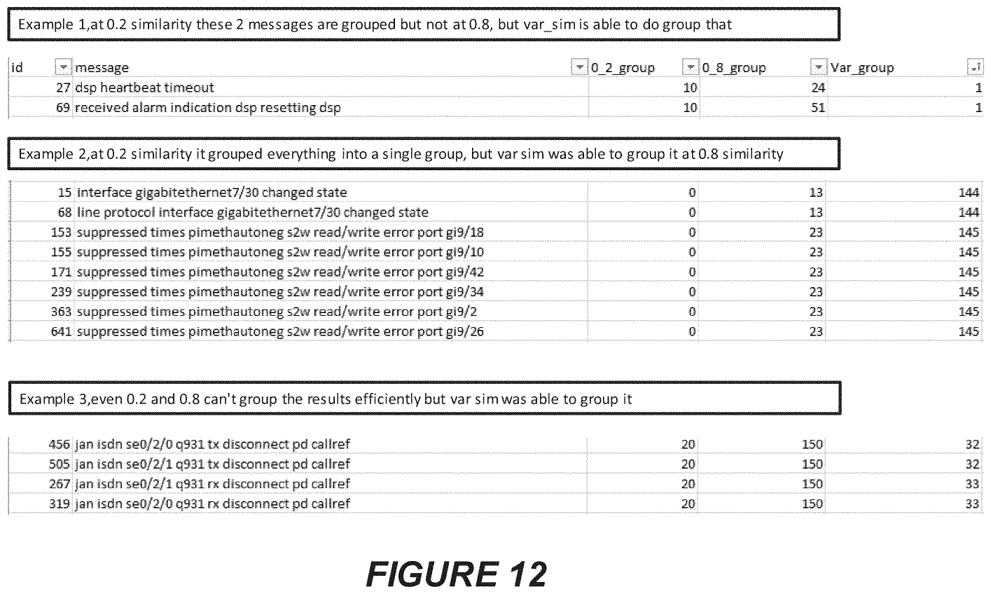

Reference is now made to FIG. 12, which is a table including comparative results using fixed value similarity thresholds and a variable similarity threshold according to some embodiments of the inventive concepts. The table includes columns for the message id, message content, clustering performance at a similarity threshold of 0.2, clustering performance at a similarity threshold of 0.8, a clustering performance at a varied similarity threshold as disclosed herein. The table includes sets of rows corresponding to three different sets of messages, Example, 1, Example 2, and Example 3.

Messages corresponding to Example 1 were able to be clustered at the 0.2 similarity threshold and the varied similarity threshold but not at the 0.8 similarity threshold. Similarly, messages corresponding to Example 2 were able to be clustered at the 0.8 similarity threshold and the varied similarity threshold but not at the 0.2 similarity threshold. Messages corresponding to Example 2 were able to be clustered at the varied similarity threshold but not at the 0.2 or the 0.8 fixed similarity thresholds. Thus, in each example, the varied similarity threshold approach consistently performed relative to the combined performance of the fixed similarity threshold approaches.

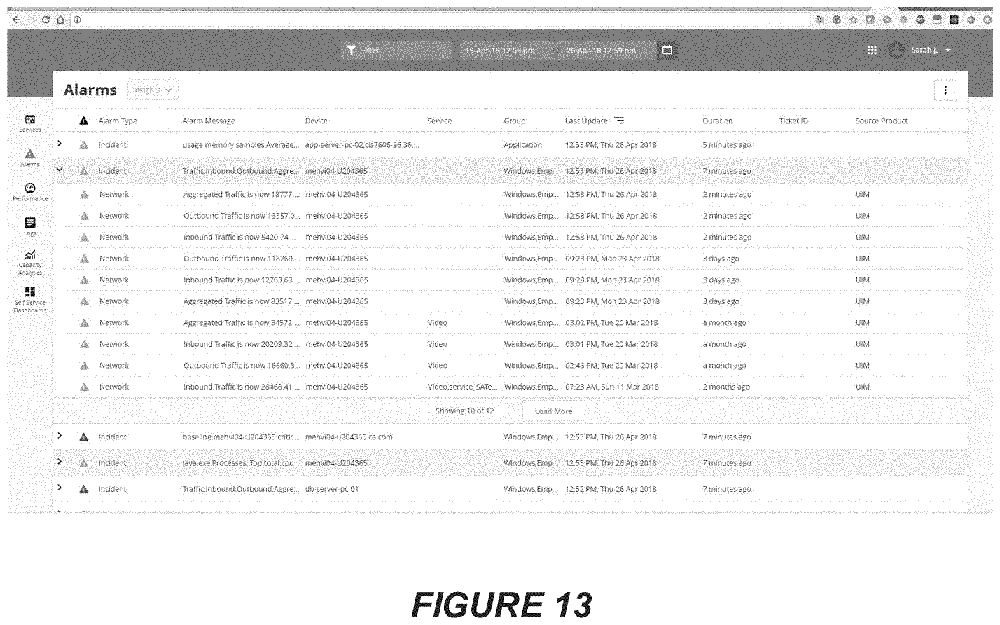

FIG. 13 is a screen shot of an example external interface for presenting alarm message scenarios according to some embodiments of the inventive concepts. As illustrated, an external interface may be used to provide the scenarios corresponding to alarm messages in a way that allows an operator to view the alarms in a meaningful manner. For example, the external interface may allow the operator to determine the relatedness of many different messages by using the scenarios for group and/or alarm type.

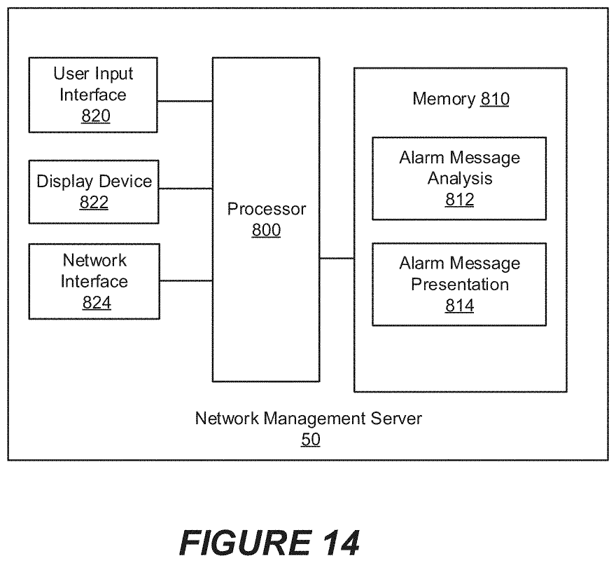

FIG. 14 is a block diagram of a device that can be configured to operate as the network management server 50 according to some embodiments of the inventive concepts. The network management server 50 includes a processor 800, a memory 810, and a network interface 824, which may include a radio access transceiver and/or a wired network interface (e.g., Ethernet interface).

The processor 800 may include one or more data processing circuits, such as a general purpose and/or special purpose processor (e.g., microprocessor and/or digital signal processor) that may be collocated or distributed across one or more networks. The processor 800 is configured to execute computer program code in the memory 810, described below as a non-transitory computer readable medium, to perform at least some of the operations described herein. The computer 800 may further include a user input interface 820 (e.g., touch screen, keyboard, keypad, etc.) and a display device 822.

The memory 810 includes computer readable code that configures the network management server 50 to implement the data collection component 106, the alarm message processor 102, the alert queue 105 and the network management function 112. In particular, the memory 810 includes alarm message analysis code 812 that configures the network management server 50 to analyze and cluster alarm messages according to the methods described above and alarm message presentation code 814 that configures the network management server to present alarm messages for processing based on the clustering of alarm messages as described above.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures. The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of processing alarm messages in a computer network administration system, comprising:
receiving a substantially real time alarm message stream that includes a plurality of alarm messages;
for each alarm message of the plurality of alarm messages:
performing a message preprocessing operation to remove low message content portions of the alarm message;
determining message term relevance corresponding to a plurality of message terms in the alarm message; and
converting the plurality message terms into a message vector; and
generating a plurality of scenarios that represent respective ones of a plurality of message clusters based on varied similarity between given ones of a plurality of message vectors.

2. The method of claim 1, further comprising transmitting the plurality of scenarios that are based on the plurality of message clusters to a system operator via an external interface.

3. The method of claim 1, wherein performing the message preprocessing operation comprises:
removing ascii characters from the plurality of alarm messages; and
removing special characters from the plurality of alarm messages.

4. The method of claim 3, wherein performing the message preprocessing operation further comprises:
excluding stop words from the plurality of alarm messages by excluding words other than nouns and verbs from the terms in the alarm messages; and
performing a natural language based tokenization on the plurality of alarm messages.

5. The method of claim 4, wherein performing the message preprocessing operation further comprises:
performing a stemming operation on the plurality of alarm messages to convert message terms that include variations of the same root term into a single stem term; and
performing a lemmatization operation on the plurality of alarm messages to convert message terms that are synonyms with one another to a single term.

6. The method of claim 1, wherein determining message term relevance corresponding to the plurality of message terms in the alarm message comprises:
determining a first frequency of use of ones of the plurality of message terms within each of the plurality of alarm messages; and
determining a second frequency of use of ones of the plurality of message terms in all of the plurality of alarm messages,
wherein the first frequency of use is negatively correlated with the message term relevance.

7. The method of claim 1, wherein generating the plurality of scenarios that represent respective ones of a plurality of message clusters based on varied similarity between given ones of a plurality of message vectors comprises generating the plurality of scenarios without receiving a similarity threshold.

8. The method of claim 1, wherein generating the plurality of scenarios that represent respective ones of a plurality of message clusters based on varied similarity between given ones of a plurality of message vectors further comprises determining a similarity matrix using a distance function, wherein the similarity matrix corresponding to N messages comprises N rows and N columns, and
wherein each element in the similarity matrix comprises a similarity value corresponding to the message row and the message column of that element.

9. The method of claim 8, wherein generating the plurality of scenarios that represent respective ones of a plurality of message clusters based on varied similarity between given ones of a plurality of message vectors further comprises generating a connected graph as an adjacency matrix representation of data in the similarity matrix.

10. The method of claim 9, wherein generating the plurality of scenarios that represent respective ones of a plurality of message clusters based on varied similarity between given ones of a plurality of message vectors further comprises generating a minimum spanning tree based on the connected graph, wherein the minimum spanning tree includes an arrangement of the messages and the distances therebetween that comprises a minimum total distance of the plurality of messages.

11. The method of claim 10, wherein generating the plurality of scenarios that represent respective ones of a plurality of message clusters based on varied similarity between given ones of a plurality of message vectors further comprises generating a broken cluster tree having the minimum spanning tree arranged in an order from a first distance to a second distance that is greater than the first distance.

12. The method of claim 11, wherein generating the plurality of scenarios that represent respective ones of a plurality of message clusters based on varied similarity between given ones of a plurality of message vectors further comprises removing clusters that do not include at least two nodes in the broken cluster tree.

13. The method of claim 12, wherein generating the plurality of scenarios that represent respective ones of a plurality of message clusters based on varied similarity between given ones of a plurality of message vectors further comprises determining similarity distances between starting and ending nodes of ones of the plurality of message clusters.

14. The method of claim 13, wherein generating the plurality of scenarios that represent respective ones of a plurality of message clusters based on varied similarity between given ones of a plurality of message vectors further comprises determining a rate of change of similarity at each of a plurality of similarity distance levels.

15. The method of claim 1, further comprising:
receiving a new alarm message;
determining a varied similarity between the new alarm message and given ones of the plurality of message vectors;
grouping the new alarm message into an existing scenario; and
displaying the new alarm message in association with the existing cluster of alarm messages.

16. A network management server comprising:
a processing circuit; and
a memory coupled to the processing circuit, the memory comprising machine-readable instructions that, when executed by the processing circuit cause the processing circuit to:
receive a substantially real time alarm message stream that includes a plurality of alarm messages;
for each alarm message of the plurality of alarm messages:
perform a message preprocessing operation to remove low message content portions of the alarm message;
determine message term relevance corresponding to a plurality of message terms in the alarm message; and
convert the plurality message terms into a message vector;
generate a plurality of scenarios that represent respective ones of a plurality of message clusters based on varied similarity between given ones of a plurality of message vectors; and
transmit the plurality of scenarios that are based on the plurality of message clusters to a system operator via an external interface.

17. The server of claim 16, wherein causing the processing circuit to perform the message preprocessing operation further causes the processing circuit to:
remove ascii characters from the plurality of alarm messages;
remove special characters from the plurality of alarm messages;
exclude stop words from the plurality of alarm messages by excluding words other than nouns and verbs from the terms in the alarm messages;
perform a natural language based tokenization on the plurality of alarm messages;
perform a stemming operation on the plurality of alarm messages to convert message terms that include variations of the same root term into a single stem term; and
perform a lemmatization operation on the plurality of alarm messages to convert message terms that are synonyms with one another to a single term.

18. The server of claim 17, wherein causing the processing circuit to determine message term relevance corresponding to the plurality of message terms in the alarm message comprises further causes the processing circuit to:
determine a frequency of use of ones of the plurality of message terms within each of the plurality of alarm messages; and
determine a frequency of use of ones of the plurality of message terms in all of the plurality of alarm messages,
wherein the frequency of use is negatively correlated with the message term relevance.

19. The server of claim 17, wherein causing the processing circuit to generate the plurality of scenarios that represent respective ones of the plurality of message clusters further causes the processing circuit to generate the plurality of scenarios without receiving a similarity threshold.

20. The server of claim 17, wherein causing the processing circuit to generate the plurality of scenarios that represent respective ones of the plurality of message clusters further causes the processing circuit to:
determine a similarity matrix using a distance function, wherein the similarity matrix corresponding to N messages comprises N rows and N columns, wherein each element in the similarity matrix comprises a similarity value corresponding to the message row and the message column of that element;
generate a connected graph as an adjacency matrix representation of data in the similarity matrix;
generate a minimum spanning tree based on the connected graph, wherein the minimum spanning tree includes an arrangement of the messages and the distances therebetween that include a minimum total distance of the plurality of messages;
generate a broken cluster tree having the minimum spanning tree arranged in an order from a first distance to a second distance that is greater than the first distance;
remove clusters that do not include at least two nodes in the broken cluster tree;
determine similarity distances between starting and ending nodes of ones of the plurality of message clusters; and
determine a rate of change of similarity at each of a plurality of similarity distance levels.
